(19) United States
(12) Patent Application Publication
(10) Pub. No.: US 2008/0043484 A1
(43) Pub. Date: Feb. 21, 2008

(54) AUTOMOBILE RADIATOR HOUSING

(75) Inventor: Kuo-Hsing LIN, Puyan Township (TW)

Correspondence Address: EGBERT LAW OFFICES, 412 MAIN STREET, 7TH FLOOR, HOUSTON, TX, 77002, US

(73) Assignee: KENG LIEN INDUSTRIAL CO., LTD., Taichung City (TW)

(21) Appl. No.: 11/464,798

(22) Filed: Aug. 15, 2006

(51) Int. Cl. F21V 33/00

(52) U.S. Cl. 362/511; 362/502

(57) ABSTRACT

The present invention provides an automobile radiator housing, which has multiple ribs placed over the hollow space of the housing. The ribs are connected to the housing, so that each rib may be taken off and replaced.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an automobile radiator housing, and more particularly to a combination with a housing and a rib.

### BACKGROUND OF THE INVENTION

Regular automobiles have a hollow space at the front of the engine, and the hollow space is mainly used to increase the amount of air coming into the engine chamber, as well as dissipating the heat in the radiator housing. So as to protect the radiator inside the engine chamber and so as to keep foreign objects from coming and hitting other components, a radiator housing consists of a cover that has ribs crossing horizontally and vertically over the hollow space to keep foreign objects out. The conventional radiator housing may be made of plastic material with vertical or horizontal ribs, or made of metal material with horizontal and vertical ribs welded onto the inner side of the frame of the radiator housing to be secure and to have a nice look. Whether they are made of plastic material or metal with ribs welded on, when part of a rib is destroyed, the entire radiator housing must be replaced instead of replacing part of the broken rib, which is not very convenient.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The advantages of the present invention are described herein.

When the ribs are placed over the housing, they are placed on the inner shoulder with the outer shoulder on both ends. They go through holes by a joint component to be secure on the locking hole, so that the ribs are placed on the housing. Compared to the conventional welding method, the present invention can be taken off and replaced.

Another new effect of the present invention is that both ends of the ribs are used to form an outer shoulder with an inner shoulder of the housing. After the rib is secured, its outer edge is flat with the outer side of the housing (as shown in FIG. 3) to achieve a better appearance.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows the exploded perspective view of the present invention.

FIG. 2 shows the assembled perspective view of the present invention.

FIG. 3 shows the partial assembled sectional view of the present invention.

FIG. 4 shows the exploded perspective view of ribs of the present invention secured by fastening strip.

FIG. 5 shows the assembled perspective view of FIG. 4 of the present invention.

FIG. 6 shows the assembled elevation view of FIG. 4 of the present invention.

FIG. 7 shows the elevation view of the ribs of the present invention as connected horizontally with fastening strip.

FIG. 8 shows the elevation view of the embodiment of the ribs secured by a fastening strip.

FIG. 9 shows a partial cross-sectional view of the embodiment of illuminating components placed on both ends of the light-guide strip.

FIG. 10 shows the assembled sectional view of the rib and light-guide strip of the present invention.

FIG. 11 shows the assembled sectional view of the illuminating component placed over the housing.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

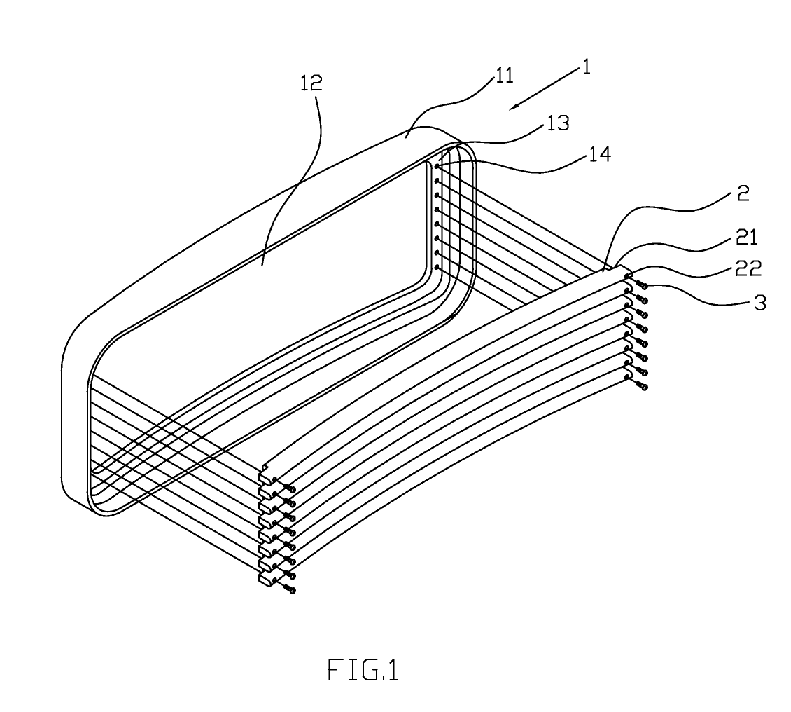

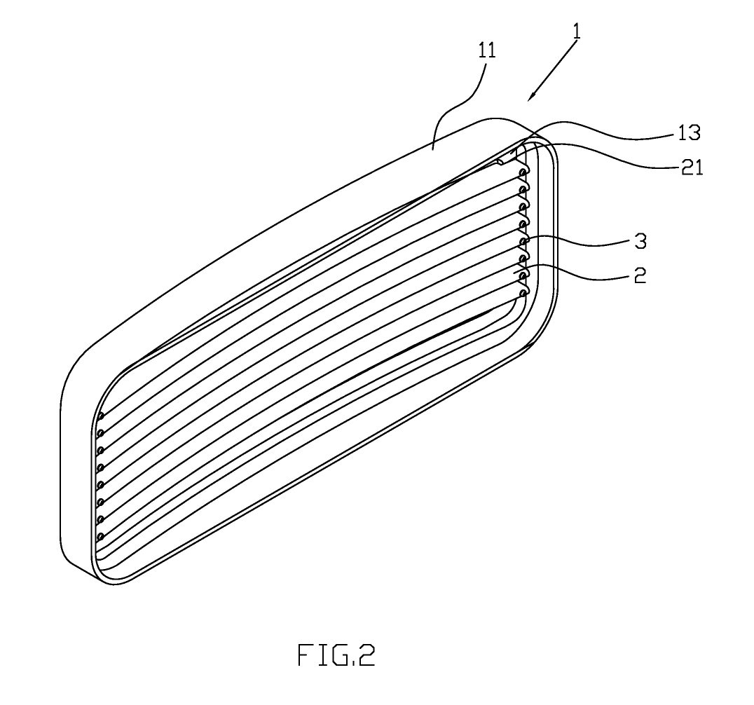

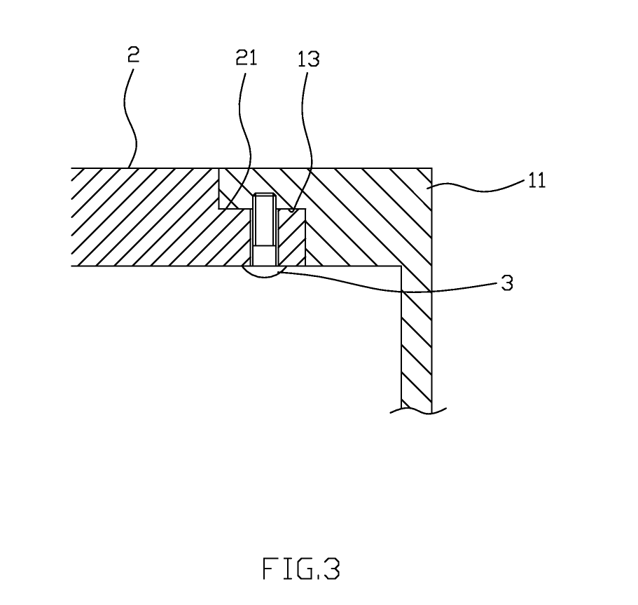

As shown in FIGS. 1˜3, there is an automobile radiator housing embodied in the present invention.

A housing 1 is placed on the front of the automobile engine chamber, and its size may be designed according to the plan of the automobile manufacturers. The shape of the present invention is presented in rectangle; however, the shape is not restricted to this shape. The housing 1 has a frame 11, and a hollow space is formed inside the frame 11. The frame of the hollow space 12 is formed inside the inner shoulder 13, and several locking holes 14 are placed on the inner shoulder 13 on both sides.

Several ribs 2 are spaced throughout the hollow space 12 of the housing 1, and both ends of the rib 2 form outer shoulder 21 with the inner shoulder 13 of the housing 1. Through hole 22 is placed on the outer shoulder 21.

With the above mentioned components, when the ribs 2 are placed over the housing 1, they are placed on the inner shoulder 13 with the outer shoulder 21 on both ends. They go through hole 22 by joint component 3 to be secure on the locking hole 14, so that the ribs are placed on the housing. Compared to the conventional welding method, the present invention can be taken off and replaced.

Another new effect of the present invention is to use both ends of the ribs 2 to form outer shoulder 21 with inner shoulder 13 of the housing. After the rib 2 is secured, its outer edge is flat with the outer side of the housing 1 to achieve a better appearance.

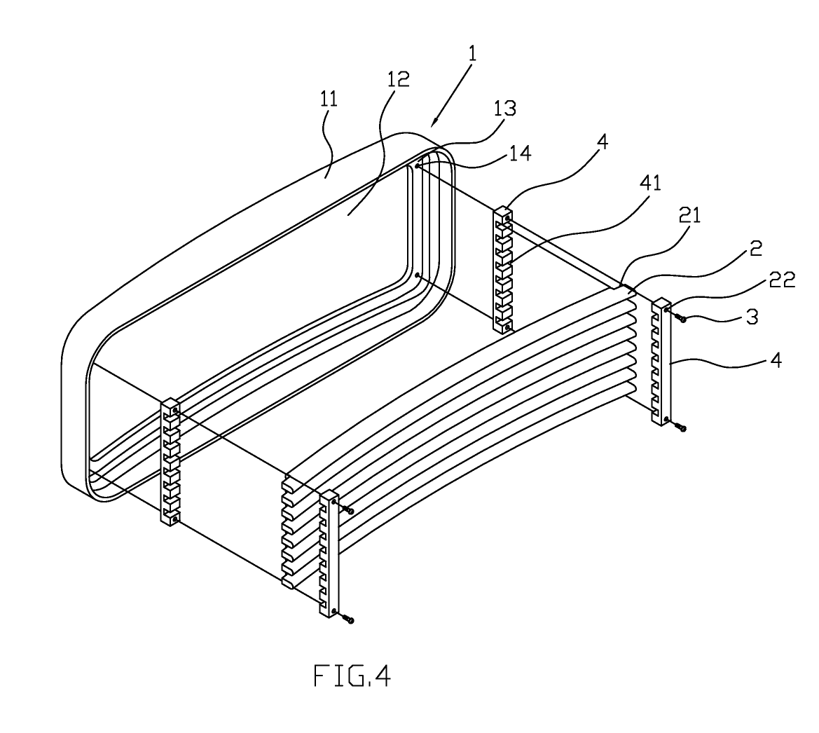

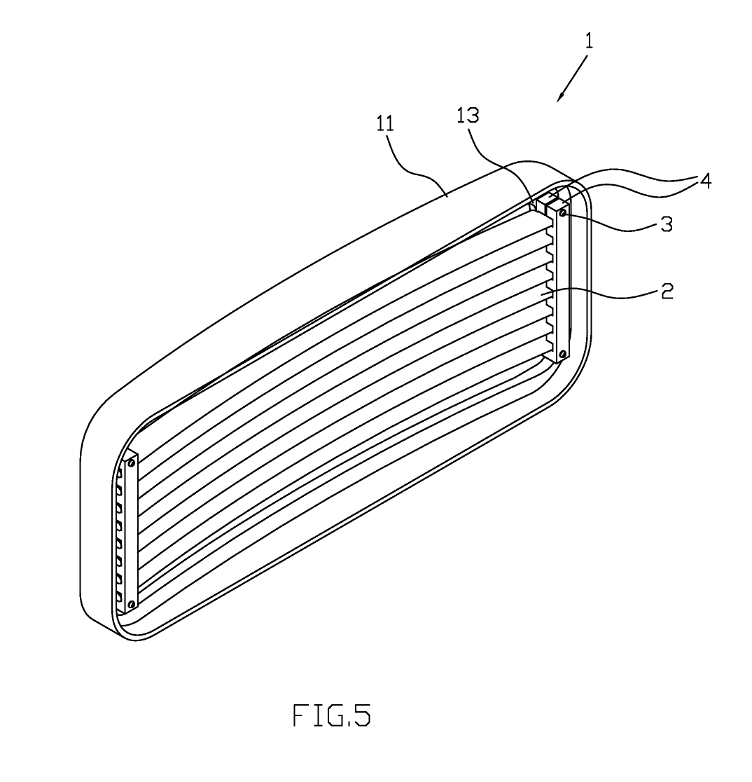

As shown in FIGS. 4, 5, there is another embodiment of the ribs of the present invention. A fastening strip 4 is placed on the inner shoulder 13 on both sides, and a slot 41 is placed on the fastening strip 4 for the outer shoulder 21 of the rib to be secured. When assembling, a fastening strip is placed over the ribs 2 after the outer shoulder 21 on both ends of the rib 2 is secured on the slot 41. Thus, both ends of rib have fastening strip 4 and are secured by the joint component 3.

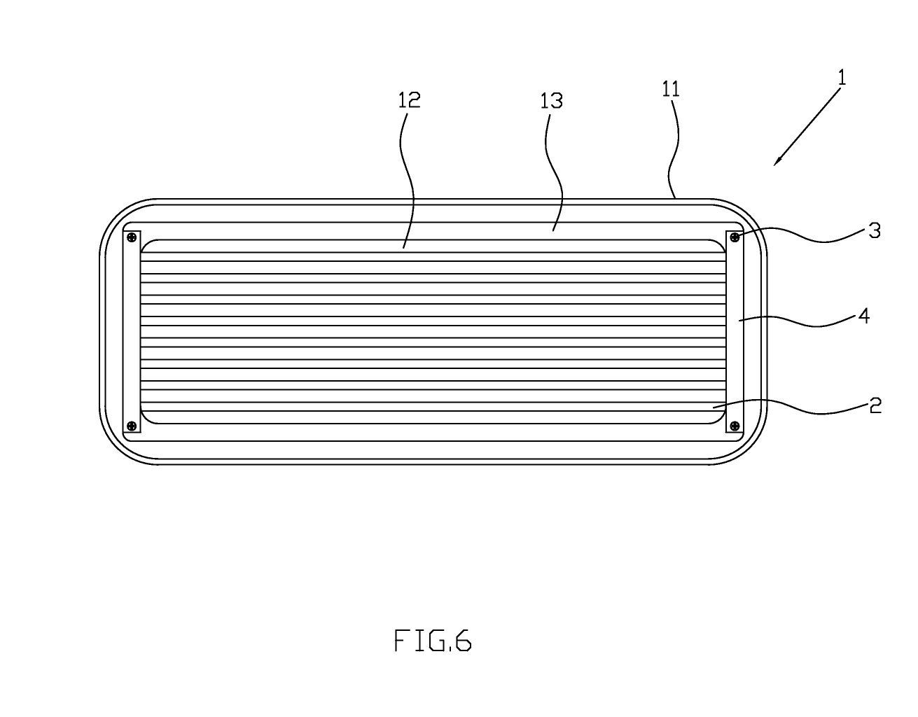

As shown in FIG. 6, several ribs 2 can be placed over the inner shoulder 13 of the housing 1 horizontally.

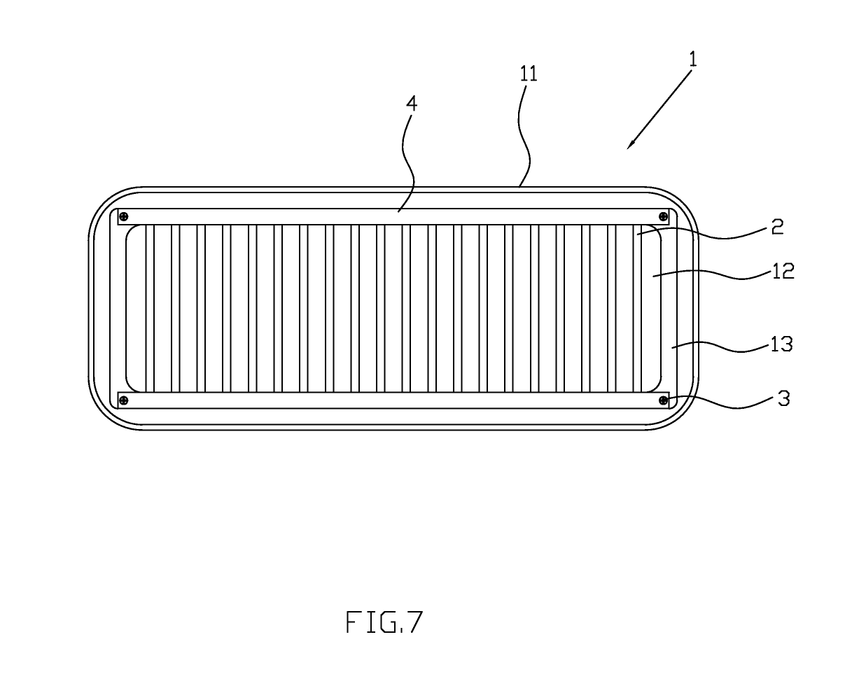

Continuing with the embodiment of FIG. 6, as shown in FIG. 7, the fastening strip 4 can be placed on the inner shoulder 13 on the top and the bottom, so that the rib 2 is secured vertically.

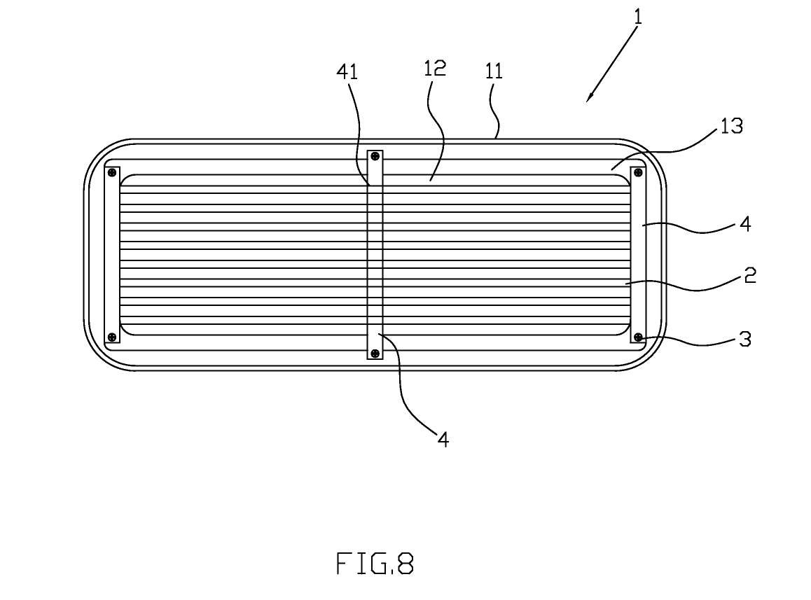

Continuing with the embodiment of FIG. 6, as shown in FIG. 8, the fastening strip 4 can be placed over the inner shoulder 13 on the top and the bottom. The slot 41 is secured to the ribs 2, so that the horizontal rib 2 may be supported in the middle.

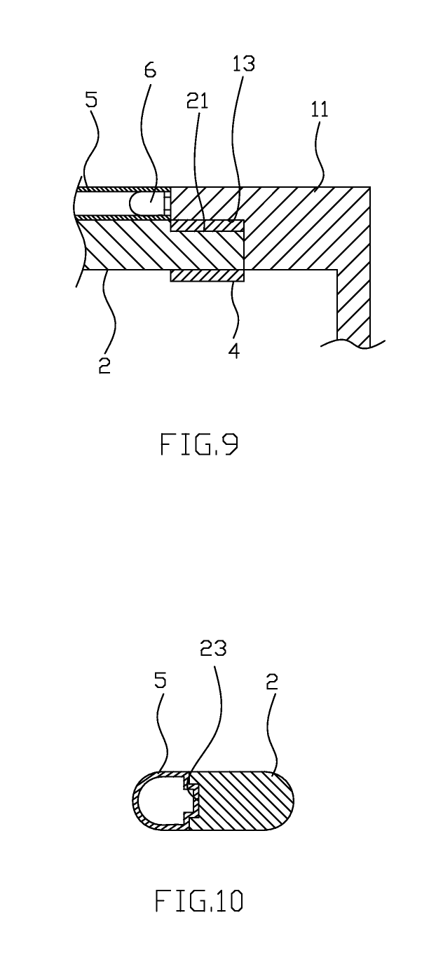

As shown in FIG. 9, there is another structural embodiment of the rib of the present invention. The outer edge of the rib 2 can be made by a light-guide strip 5, and the outer edge has a structure of a connector 23, as shown in FIG. 10. The light-guide strip 5 may be made by transparent material or night light material. An illuminating component 6 may be placed on both ends of the light-guide strip 5, so that the ribs 2 may illuminate during the night time or in the dark.

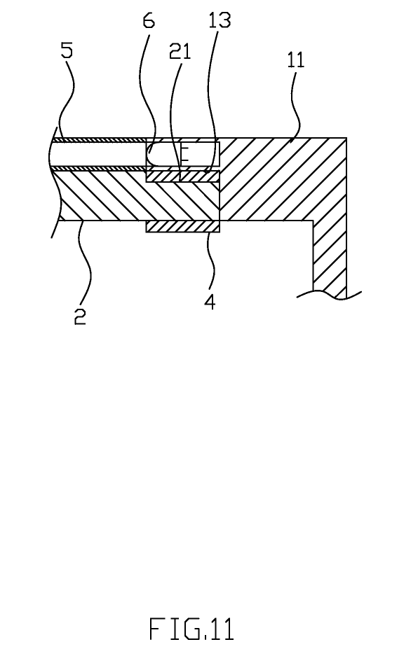

Continuing with the embodiment in FIG. 9, as shown in FIG. 11, the illuminating component 3 can be placed over the housing 1 relative to the inner part of the light-guide strip 5. The illuminating component 6 can project the light on the light-guide strip 5, so that the light-guide strip 5 may also have illuminating effect.

I claim:

1. An automobile radiator housing, comprising:
a housing having a frame, and a hollow space formed inside said frame;
several ribs, being placed throughout said hollow space of said housing;
wherein the ribs are connected to said housing, being able to be taken off and replaced when necessary.

2. The automobile radiator housing defined in claim 1, wherein said frame forms an inner shoulder in said housing, both ends of at least one rib forming an outer shoulder with said inner shoulder of said housing, the ribs each having an outer edge flat with an outer side of said housing.

3. The automobile radiator housing defined in claim 2, wherein said several ribs are placed on said inner shoulder of said housing vertically.

4. The automobile radiator housing defined in claim 2, wherein said several ribs are placed on said inner shoulder of said housing horizontally.

5. The automobile radiator housing defined in claim 2, wherein said inner shoulder has a fastening strip placed thereon, said fastening strip having a slot placed on said fastening strip secured by the ribs.

6. The automobile radiator housing defined in claim 1, wherein said housing has a fastening strip placed thereon, said fastening strip having a slot placed on said fastening strip secured by the ribs.

7. The automobile radiator housing defined in claim 5, wherein said fastening strip has both ends thereof placed on both ends of said frame of said housing, the ribs being placed in crisscross style and secured with the slot.

8. The automobile radiator housing defined in claim 5, wherein said fastening strip is placed over the ribs after both ends of at least one rib is secured on said slot, both ends of the rib having a fastening strip.

9. The automobile radiator housing defined in claim 1, wherein each rib has an outer edge with a light-guide strip, said light-guide strip being comprised of transparent material or night light material.

10. The automobile radiator housing defined in claim 9, further comprising:
an illuminating component placed on said housing on both ends of said light-guide strip.

11. The automobile radiator housing defined in claim 9, further comprising:
an illuminating component placed on both ends of said light-guide strip.

12. The automobile radiator housing defined in claim 1, wherein each rib is secured to said housing by joint component.
